(19) United States
(12) Patent Application Publication
(10) Pub. No.: US 2006/0078234 A1
(43) Pub. Date: Apr. 13, 2006

(54) Flexible intermediate bulk container having optimum discharge of hazardous charge

(75) Inventors: N. Satish Chandra, Lansdale, PA (US); William F. McNally, Clarks Summit, PA (US); Frank T. McNally, Kennett Square, PA (US); Joseph Diehl, Avoca, PA (US)

Correspondence Address: AKERMAN SENTERFITT, P.O. BOX 3188, WEST PALM BEACH, FL, 33402-3188, US

(73) Assignee: Noble Fiber Technologies, LLC, Scranton, PA (US)

(21) Appl. No.: 11/249,113

(22) Filed: Oct. 11, 2005

Related U.S. Application Data
(60) Provisional application No. 60/617,774, filed on Oct. 12, 2004.

(51) Int. Cl. B65D 33/00; B65D 30/04; B29C 70/08

(52) U.S. Cl. 383/105; 383/117; 428/36.3

(57) ABSTRACT

A flexible intermediate bulk container having optimum discharge of hazardous charge. Conventional flexible containers are capable of carrying materials that may ignite if contacted with a charge. The container of the instant invention permits the safe handling of flexible intermediate bulk containers, either with or without grounding. Unlike many prior art systems, the container, in one embodiment, does not include an anti-static coating, thereby resulting in cost and time savings. The electrostatic yarn of the present invention may be incorporated into any bag or container system without any modifications in the process of forming the yarn. The yarn may be used in either flat or circular weave, and the yarn may be included in fabrics used in other materials besides containers or bags.

### CROSS REFERENCE TO RELATED APPLICATION

This application claims the benefit of U.S. Provisional Application No. 60/617,774, filed Oct. 12, 2004.

### FIELD OF THE INVENTION

This invention is directed generally to containers, and more particularly to flexible intermediate bulk containers.

### BACKGROUND OF THE INVENTION

Containers formed of flexible fabric are being used in commerce more and more widely to carry low viscosity materials in bulk quantities. Flexible intermediate bulk containers (IBCs) have been utilized for a number of years to transport and deliver finely divided solids such as cement, fertilizers, salt, sugar, and barite, among others. Such bulk containers can in fact be utilized for transporting almost any type of free-flowable finely divided solid. The fabric from which they are generally constructed is a weave of a polyolefin, e.g., polypropylene, which may optionally receive a coating of a similar polyolefin on one or both sides of the fabric. Such a coating makes the fabric non-porous, and conversely, fabric without such coating is porous. The usual configuration of such flexible bulk containers involves a rectilinear or cylindrical body having a wall, base, cover, and a closable spout secured to extend from the base or the top or both.

In many instances, IBCs are handled by placing the forks of a forklift hoist through loops attached to the IBCs. It has been found that the shifting of specific materials within containers made of woven fabrics, as well as particle separation between the materials and such containers during loading and unloading of the container, cause triboelectrification and create an accumulation of static electricity on the container walls. In addition, the accumulation of static electricity is greater at lower relative humidity and increases as the relative humidity drops. Also, highly charged material entering such containers can create an accumulation of static electricity on the container walls. Electrostatic discharges from a charged container can be incendiary, i.e. cause combustion in dusty atmospheres or in flammable vapor atmospheres. Moreover, discharges can be quite uncomfortable to workers handling such containers.

One conventional approach to solving this problem is the use of a grounded container. These containers are often referred to as “C” containers. Such a container may include conductive fibers that are electrically connected to ground to carry the electric energy out of the bag. The use of a grounded container, however, works only if the container is grounded. If the container becomes ungrounded, the container loses the ability to decrease the potential for an incendiary discharge. In addition, the discharge can be more energetic and incendiary than conventional non-conductive containers because of the higher capacitance of the conductive system. Additionally, fabrication of the conductive containers requires specialized construction techniques to ensure all conductive surfaces are electrically connected together for a ground source.

Another conventional approach to decreasing the potential for incendiary discharges in flexible containers has been to decrease the surface electrostatic field of the container. If the magnitude of the electrostatic field on the surface of a container is above a certain threshold level, the potential for an incendiary discharge due to the electrostatic charge exists. The threshold level is about 500 kilovolts per meter (kV/m) for intermediate bulk containers made from woven polypropylene fabric. By decreasing the surface electrostatic field below about 500 kV/m, the potential for an incendiary discharge is greatly decreased and believed to be rendered virtually non-existent. Attempts at reducing the surface electrostatic field level below about 500 kV/m have not, however, proven successful without proper grounding.

One such effort of decreasing surface electrostatic fields has focused on the creation of corona discharges. There are four basic types of electrostatic discharges: spark discharges; brush discharges; propagating brush discharges; and, corona discharges. Of the four electrostatic discharges, the spark, the brush and the propagating brush discharges can create incendiary discharges. The corona discharge is not known to create incendiary discharges for common flammable atmospheres.

Materials have been included in flexible fabric containers to limit corona discharges as the electrostatic field increases to a maximum level. The maximum electrostatic field level typically is about 500 kV/m. Electrostatic fields above this level include a risk of incendiary discharge.

Other efforts are focused on using higher resistance containers, on the order of 10¹⁰ to 10¹² Ohms, such that the containers do not need to be grounded. These types of containers are referred to as “D” containers. While the containers do not need to be grounded, in use, everything around the container does need to be grounded, including equipment or workers, or both. Otherwise, the same risk of incineration exists as for “C” containers. Many of these containers achieve this higher resistivity through the use of coatings on the container.

Accordingly, a need exists for a flexible container that does not need to be grounded and does not require the persons or equipment proximate to the container to be grounded as well. Also, a need exists for a flexible container is not dependent on humidity to discharge safely.

### SUMMARY OF THE INVENTION

The invention is directed to a flexible container having optimum discharge of hazardous charge. The flexible container provides a method of electrostatic discharge (ESD) utilizing optimum resistivity, thereby resulting in the safe discharge of static electricity that may have accumulated on a fabric. The invention may utilize a wrapping technique to place a high-resistance system on the outside of a carrier yarn. The flexible container may be used in any conventional “D system” as there is no requirement that the flexible container be grounded during use.

In at least one embodiment, the flexible container may be formed from an outer wall forming a chamber configured to hold a material during transport, wherein the outer wall may be formed from a fabric including at least one electrostatic yarn formed from a metallized yarn coupled to a carrier yarn. The metallized yarn may have a resistance of from about 10⁷ to about 10⁹ Ohms. The carrier yarn may be selected from poly(ethylene terephthalate) yarn, poly(trimethylene terephthalate) yarn, cotton yarn, wool yarn, polyester yarn, polyamide yarn, polyacrylic yarn, polyvinyl yarn, polypropylene yarn, hemp, silk, a regenerated cellulose yarn, rayon, polynosic, an acetate yarn, nylon fibers, or a combination thereof. The electrostatic yarns may be positioned generally parallel with each other in the fabric and may be spaced apart from each other a distance between about 0.3 to about four inches. In another embodiment, the electrostatic yarns may be spaced apart from each other a distance between about nine to about eighteen inches.

In another embodiment, the electrostatic yarn may be formed from at least two metallized yarns coupled to a carrier yarn in a wrapped, X pattern. In another embodiment, the electrostatic yarn may be formed from one metallized yarn and a non-metallized yarn coupled to a carrier yarn in a wrapped, X pattern.

An advantage of this invention is a flexible container constructed with electrostatic fibers, as described herein, provides a transportation system guarded against fire caused by electrostatic discharge whether or not the flexible container is grounded.

Another advantage of this invention is a flexible container having antimicrobial properties.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a flexible bulk container including aspects of the invention.

FIG. 2 is a detail view of an outer surface of the flexible bulk container taken at detail line 2-2 in FIG. 1.

FIG. 3 is a perspective view of metallized yarn being twisted around a carrier yarn.

FIG. 4 is a perspective view of a an alternative embodiment of a metallized yarn being twisted around a carrier yarn.

### DETAILED DESCRIPTION OF THE INVENTION

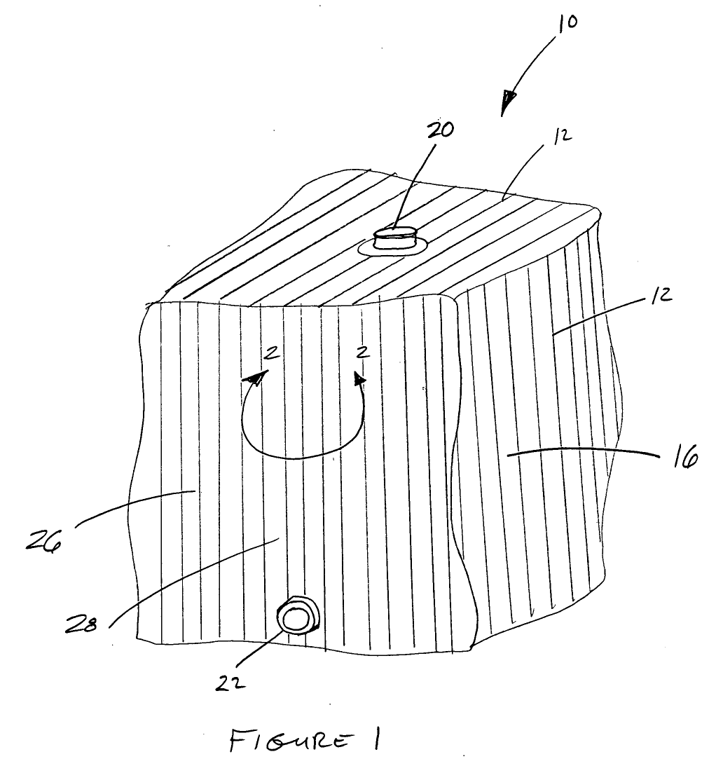

As shown in FIGS. 1-4, the present invention is directed to a flexible container 10 having optimum discharge of hazardous charge. The flexible container 10 may be formed using an electrostatic yarn 12 that has increased resistance, such that the resulting containers 10 do not need to be grounded. The electrostatic yarns 12 of the present invention may be formed from a metallized higher resistance yarn 13 and a carrier yarn 14. The metallized yarn may also act as a antimicrobial agent in devices in which the metallized yarn is included. The metallized higher resistance yarn 13 and the carrier yarn 14 may be used to form electrostatic yarns of the present invention using processes that reduce the cost of making the containers 10 or other fabrics.

The electrostatic yarns 12 of the present invention utilize a metallized higher resistance yarn. As used herein, a “metallized higher resistance yarn or spun yarn system” is any yarn having a metal thereon or therein and having a resistance in the range of from about 10⁷ to about 10¹³ Ohms. In one embodiment, the denier of the metallized higher resistance yarn 13 may be between 0.5 denier per filament (dps) to five dps, and in one embodiment, may be about two dps. In the instant invention, about 0.5 percent to about 30 percent of a fabric 16 forming an IBC 10 or other container or material may be formed from materials having antistatic properties, and the remaining portions of the fabric 16 may be formed from any natural or synthetic staple yarn, such as, but not limited to, cotton, polyester, and other appropriate materials. Higher denier material may also be used; however, in general, the cost increases as the denier of the metallized yarn increases. As such, for cost considerations, 50 denier products may be generally used.

The metal used in the metallized higher resistance yarn 13 may be any metal capable of providing the selected resistance. In one embodiment, the metal may be silver. In alternative embodiments, the metal may include, but not be limited to, copper, aluminum, zinc, nickel, or the like.

In some embodiments, the metallized higher resistance yarn 13, may be combined with a strengthening yarn. In one embodiment, the strengthening yarn may be a polypropylene yarn. In other embodiments, the strengthening yarn may be formed from other materials, such as, but not limited to polyethylene.

The metallized yarn 13 or strengthened metallized yarns 13 may be combined with a carrier yarn 14 to form the electrostatic yarns of the present invention. The carrier yarn 14 may be any type of yarn used in woven or non-woven fabrics. In general, the carrier yarn 14 have a denier of from about 100 to about 1800 deniers, which permits flexibility of using the yarn in any kind of construction. It in other embodiments, carrier yarns 14 having higher denier may also be used depending on the final end use of the yarn. Any suitable carrier yarn 14 may be used in the present invention. Examples of carrier yarns 14 that may be used include, but are not limited to, poly(ethylene terephthalate) (PET) yarn, poly(trimethylene terephthalate) (PTT) yarn, cotton yarn, wool yarn, polyester yarn, polyamide yarn, polyacrylic yarn, polyvinyl yarn, polypropylene yarn, hemp, silk, a regenerated cellulose yarn, rayon, polynosic, an acetate yarn, nylon fibers, or a combination thereof.

The electrostatic yarn 12 or strengthened metallized yarns may be combined with the carrier yarn 14 using different processes to facilitate different properties of the electrostatic yarns 12 of the present invention. In one embodiment, the electrostatic yarn 12 may be formed by twisting the metallized yarn 13 to roll onto the carrier yarn 14, thereby resulting in the metallized yarn 13 being placed on the outside of the carrier yarn 14. This configuration is different from conventional twisting whereby the position of the metallized yarn on the carrier yarn is not controlled.

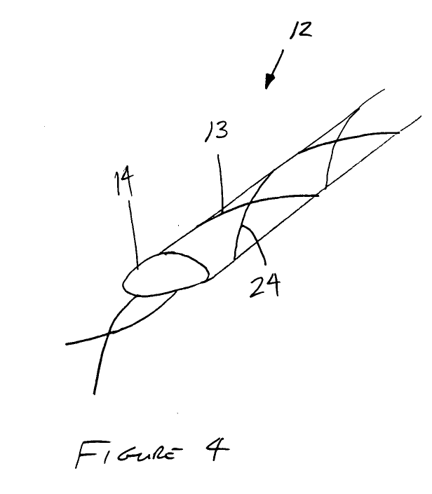

In an alternative embodiment, as shown in FIG. 3, the metallized electrostatic yarn 13 may be configured in an “X” pattern using a technique called as “wrapping.” Two ends of metallized yarn 13 may be twisted on the outside of the carrier yarn 14 to produce an “X” configuration. In another embodiment, as shown in FIG. 4, a metallized yarn 13 may be wrapped with a non-metallized yarn 24 to form an electrostatic yarn at a reduced cost.

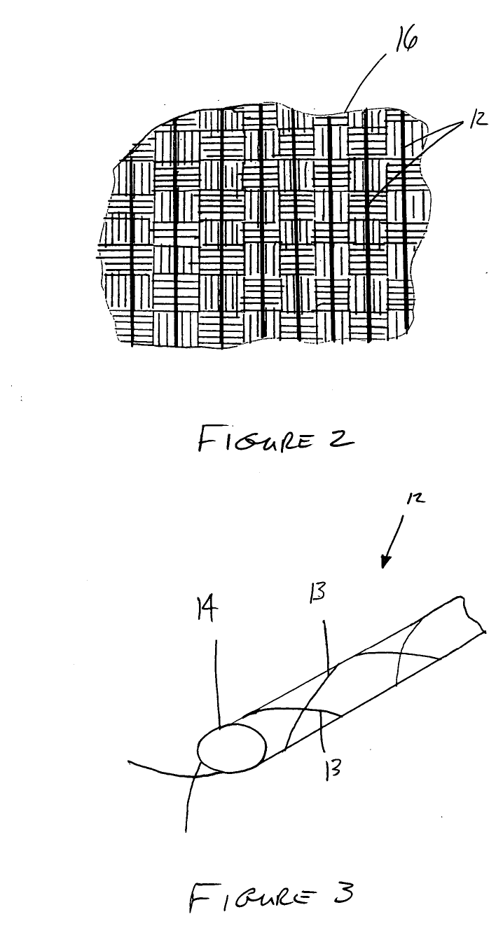

The electrostatic yarn 12 may be incorporated into a container 10 or other fabric. If the weave is flat kind, the electrostatic yarn 12 may be woven in the warp direction, as shown in FIG. 2, and separated between about 0.3 inches to about four inches apart, and in one embodiment, may be separated about 0.67 inches apart. In yet another embodiment, the electrostatic yarn 12 may be separated between about nine inches and about eighteen inches apart. The spacing is applicable for portions of an IBC container 10 surrounding a inlet valve 20 and a release valve 22. In an alternative embodiment in which electrostatic yarns 12 may be used for a circular weave, the electrostatic yarn 12 may be included in only the warp direction in the fabric.

As shown in FIG. 1, the flexible container 10 may be formed from an outer wall 26 forming a chamber 28 configured to hold a material during transport. The flexible container 10 may be formed in a variety of configurations depending on the application. In at least one embodiment, the flexible container 10 may be configured to provide sufficient support without other assistance. In another embodiment, the flexible container may be supported with an external frame or other device.

The electrostatic yarns 12 formed by the present invention may be formed into fabrics and other woven and non-woven materials using techniques well known in the art. For example, for a woven fabric, the yarns 12 may be interwoven on a textile loom to form a sheet-like material relatively free of interstices. The tightness of the weave may be selected based upon a variety of different factors including, but not limited to, the end use of the container. For example, where the fabric is to be used to form containers for holding large particle size bulk material such as tobacco or pellets, then a fairly open weave of mono or multifilament yarn may be used in a count range of from about 1000 to 3000 denier in each weave direction.

The overall resistance of the fabrics or containers 10 of the present invention may be from about 10⁹ to about 10¹⁴ Ohms. The resistance is not low enough to require being grounded all times. It is also not so high that it is difficult to check the resistance of each bag to ensure safety.

An embodiment of the invention was tested for discharge incendivity. The fabric that was tested included generally vertical threading spaced approximately every two centimeters. Polypropylene pellets, charged to about −30 kilovolts (kV) with about −3.0×10⁻⁶ A at both ambient and low humidity, were discharged onto the fabric. The incendivity of electrostatic charges from the fabric surfaces was measured using a gas emitting probe. Discharge incendivity was tested by attempting to produce electrostatic discharges from the charged fabric surfaces using the gas emitting probe. A total of two hundred tests were run under ambient humidity, and two hundred tests were run under low humidity conditions. None of the test runs resulted in electrostatic discharges having sufficient energy to ignite a flammable atmosphere.

While the present invention has been described in relation to its use in flexible containers 10, electrostatic yarns 12 may be used in other applications as well. Examples of other applications include, but are not limited to, pneumatic conveyor tubes, gravity slides, clothing to be worn by individuals working around flammable and/or incendiary materials, or liners in containment vessels.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. A flexible container, comprising:
an outer wall forming a chamber configured to hold a material during transport;
wherein the outer wall is formed from a fabric including at least one electrostatic yarn formed from a metallized yarn coupled to a carrier yarn.

2. The flexible container of claim 1, wherein the metallized yarn has a resistance of from about 10⁷ to about 10⁹ Ohms.

3. The flexible container of claim 1, wherein the carrier yarn is selected from the group consisting of poly(ethylene terephthalate) yarn, poly(trimethylene terephthalate) yarn, cotton yarn, wool yarn, polyester yarn, polyamide yarn, polyacrylic yarn, polyvinyl yarn, polypropylene yarn, hemp, silk, a regenerated cellulose yarn, rayon, polynosic, an acetate yarn, nylon fibers, and a combination thereof.

4. The flexible container of claim 1, further comprising a plurality of electrostatic yarns positioned generally parallel with each other in the fabric; wherein the electrostatic yarns are spaced apart from each other a distance between about 0.3 to about four inches.

5. The flexible container of claim 1, further comprising a plurality of electrostatic yarns positioned generally parallel with each other in the fabric; wherein the electrostatic yarns are spaced apart from each other a distance between about nine to about eighteen inches.

6. The flexible container of claim 1, wherein the electrostatic yarn is formed from at least two metallized yarns coupled to a carrier yarn in a wrapped, X pattern.

7. The flexible container of claim 1, wherein the electrostatic yarn is formed from one metallized yarn and a non-metallized yarn coupled to a carrier yarn in a wrapped, X pattern.

8. An electrostatic yarn, comprising:
a carrier yarn; and
a metallized yarn having at least one metal applied to an outer surface of the yarn and coupled to the carrier yarn.

9. The electrostatic yarn of claim 8, wherein the metallized yarn has a resistance of from about 10⁷ to about 10⁹ Ohms.

10. The electrostatic yarn of claim 8, wherein the carrier yarn is selected from the group consisting of poly(ethylene terephthalate) yarn, poly(trimethylene terephthalate) yarn, cotton yarn, wool yarn, polyester yarn, polyamide yarn, polyacrylic yarn, polyvinyl yarn, polypropylene yarn, hemp, silk, a regenerated cellulose yarn, rayon, polynosic, an acetate yarn, nylon fibers, and a combination thereof.
